(19) United States
(12) Patent Application Publication
(10) Pub. No.: US 2014/0043827 A1
(43) Pub. Date: Feb. 13, 2014

(54) LED LIGHTING APPARATUS

(71) Applicant: POSCO LED COMPANY LTD., Seongnam-si (KR)

(72) Inventors: Jin Jong Kim, Seongnam-si (KR); Jae Young Choi, Seongnam-si (KR); Jung Hwa Kim, Seongnam-si (KR); Ji Wan Kim, Seongnam-si (KR); Hyun-Ku Park, Seongnam-si (KR); Sun Min Park, Seongnam-si (KR)

(21) Appl. No.: 13/919,328

(22) Filed: Jun. 17, 2013

(30) Foreign Application Priority Data
Aug. 9, 2012 (KR) 10-2012-0087152
Feb. 28, 2013 (KR) 10-2013-0021989

(51) Int. Cl. F21K 99/00

(52) U.S. Cl. CPC F21K 9/50
USPC 362/311.02

(57) ABSTRACT

An exemplary embodiment of the present invention discloses a light emitting diode (LED) lighting apparatus with a housing, a lighting module and a diffusion cover. The lighting module includes a circuit board combined with the housing, and a plurality of light emitting diodes mounted on the circuit board to generate light, the light emitting diodes in a first region being arranged with a first distance and the light emitting diodes in a second region being arranged with a second distance that is greater than the first distance. The diffusion cover is combined with the housing such that the diffusion cover covers the lighting module. The diffusion cover has a groove portion at a region corresponding to the second region.

### CROSS REFERENCE TO RELATED APPLICATIONS

This application claims priority from and the benefit of Korean Patent Application No. 10-2012-0087152, filed on Aug. 9, 2012, and Korean Patent Application No. 10-2013-0021989, filed on Feb. 28, 2013, which are hereby incorporated by reference for all purposes as if fully set forth herein.

### BACKGROUND OF THE INVENTION

1. Field of the Invention

Exemplary embodiments of the present invention relate to a light emitting diode (LED) lighting apparatus or, more particularly, to an LED lighting apparatus generating planar light by using light emitting diode which corresponds to a point light source.

2. Discussion of the Background

In general, a fluorescent lamp or an incandescent lamp is used in a house or an office as an indoor lighting apparatus, but the fluorescent lamp is more frequently used than the incandescent lamp since the fluorescent lamp has more effective. However, the fluorescent lamp has still relatively lower luminance and less effective than an LED lighting apparatus having light emitting diodes. Therefore, usage of the LED lighting apparatus is increasing now.

The LED lighting apparatus generally includes a housing that is a case of the lighting apparatus, a light generating module having a circuit board and a plurality of light emitting diodes mounted on the circuit board, and a diffusion plate. Unlike the fluorescent lamp or the incandescent lamp, the LED lighting apparatus includes a power supply for converting a commonly used alternating electric power to an appropriate electric power (for example, a direct electric power). Using the power supply converting the commonly used alternating electric power to direct electric power, a plurality of light emitting diodes generates light, and the light generated by the light emitting diodes which is point light source is diffused by the diffusion plate to be planar light.

However, according to the conventional LED lighting apparatus, a plurality of light emitting diodes is arranged uniformly to generate uniform planar light without a dark region to induce increasing the price thereof, and the light emitting diodes disposed adjacent to the power supply are deteriorated due to heat generated by the power supply and electric interference of the power supply to induce relative dark region.

### SUMMARY OF THE INVENTION

Exemplary embodiments of the present invention provide an LED lighting apparatus capable of reducing manufacturing cost thereof and generating uniform light without a dark region.

Additionally, exemplary embodiments of the present invention provide an LED lighting apparatus applicable to various applications such as a buried lighting apparatus and a pendant lighting apparatus through separately manufacturing a lighting section having a light generating module and a frame for installing the LED lighting apparatus.

Additional features of the invention will be set forth in the description which follows, and in part will be apparent from the description, or may be learned by practice of the invention.

An exemplary embodiment of the present invention discloses a LED lighting apparatus with a housing, a lighting module and a diffusion cover. The lighting module includes a circuit board combined with the housing, and a plurality of light emitting diodes mounted on the circuit board to generate light, the light emitting diodes in a first region being arranged with a first distance and the light emitting diodes in a second region being arranged with a second distance that is greater than the first distance. The diffusion cover is combined with the housing such that the diffusion cover covers the lighting module. The diffusion cover has a groove portion at a region corresponding to the second region.

For example, the LED lighting apparatus may further include a power supply combined with the housing in a region corresponding to the second region. The power supply provides the lighting module with electric power.

The second region may be disposed between two first regions.

The lighting module may include a first lighting module section combined with the housing at a first side and a second lighting module section combined with the housing at a second side opposite to the first side such that the second lighting module section is spaced apart from the first lighting module section.

The second region may correspond to a region between the first and second lighting module sections.

The lighting module may include at least three lighting module sections combined with the housing such that the lighting module sections are spaced apart from each other, and a plurality of groove portions may be formed at a region between the lighting modules, respectively.

The groove portions may extend along a longitudinal direction of the second region. The groove portion may have a rounded cross-sectional shape. The groove portion may have a depth corresponding to a difference of a first height, at which two lights emitted by two light emitting diodes spaced apart from each other with the first distance overlap, and a second height at which two lights emitted by two light emitting diodes spaced apart from each other with the second distance overlap.

The diffusion cover may includes a combination portion combined with the housing, a sidewall portion extending from the combination portion, and a diffusing portion extending from the sidewall portion to the groove portion.

The diffusing portion may be formed such that a distance between the diffusion portion and the lighting module gradually increases from the sidewall portion to the groove portion.

The groove portion may be disposed between a height at which the sidewall portion and the diffusing portion meet each other, and a height at which the diffusing portion and the groove portion meet each other.

The LED lighting apparatus may further include a frame for installing the LED lighting apparatus to outside, which is combined with the housing. The frame may include a housing-combination portion disposed between a sidewall of the housing and the sidewall portion of the diffusion cover to be combined with the housing, a frame portion outwardly extending from the housing-combination portion, and a installing portion for installing the LED lighting apparatus to outside, which formed at an edge of the frame portion.

Another exemplary embodiment of the present invention discloses a LED lighting apparatus with a housing, a lighting module, a power supply and a diffusion cover. The lighting module has a first lighting module section combined with the housing at one side, and a second lighting module section combined with the housing at an opposite side such that the second lighting module section is spaced apart from the first lighting module section. The power supply is combined with a back surface of the housing to provide the lighting module with electric power. The diffusion cover is combined with the housing to cover the lighting module. The diffusion cover has a groove portion at a region thereof, which corresponds to a region between the first and second lighting module sections.

The first and second lighting modules section respectively may include light emitting diodes arranged with a first distance, and a light emitting diode of the first lighting module section, which is nearest to the second light module section, and a light emitting diode of the second lighting module section, which is nearest to the first lighting module section, are spaced apart with a second distance.

The LED lighting apparatus may further include a frame for installing the LED lighting apparatus to outside.

According to the LED lighting apparatus of the present invention, a number of the light emitting diodes can be reduced to reduce manufacturing cost and the deterioration of the light emitting diodes can be minimized by increasing a distance between the light emitting diodes in corresponding to a position of the power supply.

Further, a relative dark region induced by height difference of light overlapping may be reduced by forming the groove portion at the diffusion cover, the groove portion having a depth corresponding to the height difference of light overlapping.

Further, the LED lighting apparatus may be used both as a buried type or a pendant type by the housing and the frame which are separably combined with each other.

Further, the thickness of the LED lighting apparatus may be reduced and convenience of assembling and disassembling may be enhanced by disposing the first lighting module, the second lighting module and the power supply on a same plane of the heat sink.

Further, a convenience of assembling and disassembling is more enhanced by combining the power supply cover, the first diffusion cover and the second diffusion cover through a Z-bending method in comparison with a screw method.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view illustrating an LED lighting apparatus according to an exemplary embodiment of the present invention.

FIG. 2 is an exploded cross-sectional view illustrating the LED lighting apparatus of FIG. 1.

FIG. 3 is a cross-sectional view illustrating the LED lighting apparatus of FIG. 2, which is assembled.

FIG. 4 is a cross-sectional view illustrating a housing and a diffusion cover of FIG. 2, which are combined with each other.

FIG. 5 is a conceptual view illustrating a light profile generated by lighting module.

FIG. 6 is a cross-sectional view illustrating an LED lighting apparatus according to another exemplary embodiment of the present invention.

FIG. 7 is a partially enlarged view illustrating a combination of a housing and a frame.

FIG. 8 is an exploded perspective view illustrating an LED lighting apparatus according to another exemplary embodiment of the present invention.

FIG. 9 is cross-sectional view illustrating the LED of FIG. 8, which is assembled.

FIG. 10 is an exploded perspective view illustrating a process of assembling power supply cover.

FIG. 11 is a cross-sectional view illustrating a process of assembling power supply cover.

FIG. 12 is a cross-sectional view illustrating the power supply cover which is assembled.

FIG. 13 is an exploded perspective view illustrating a process of assembling a diffusion cover.

FIG. 14 is a cross-sectional view illustrating the diffusion cover which is assembled.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

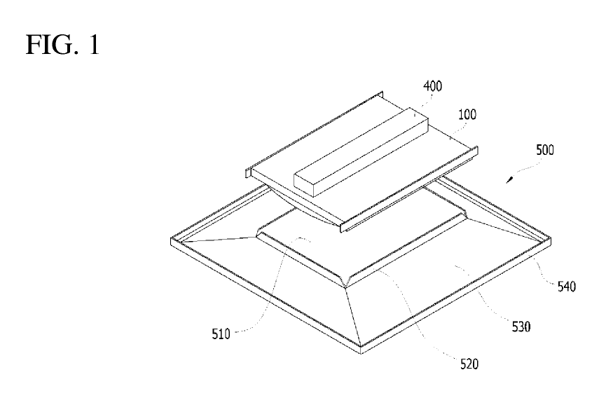

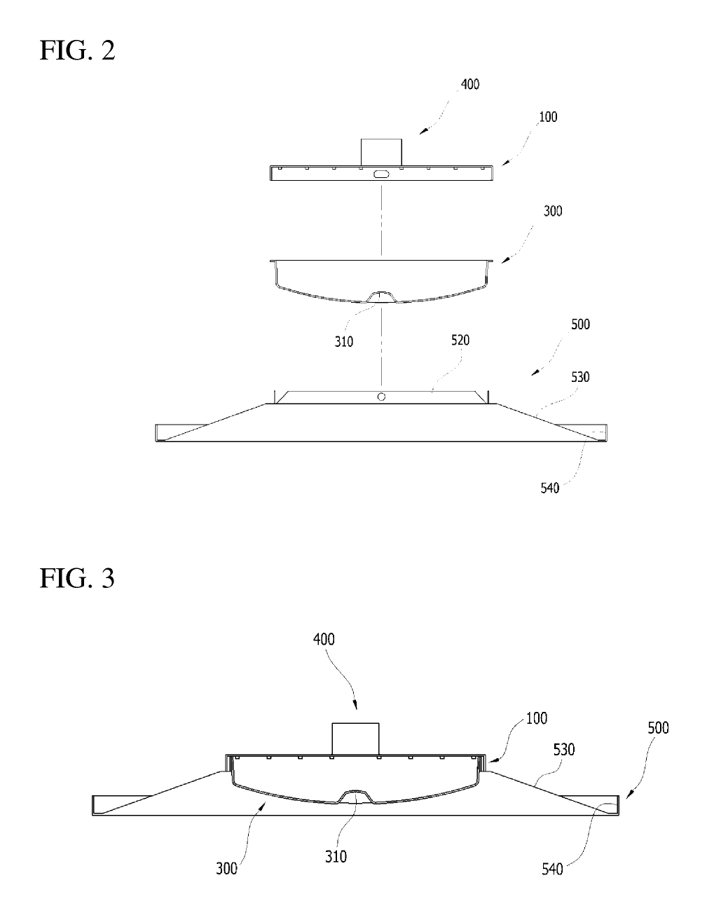

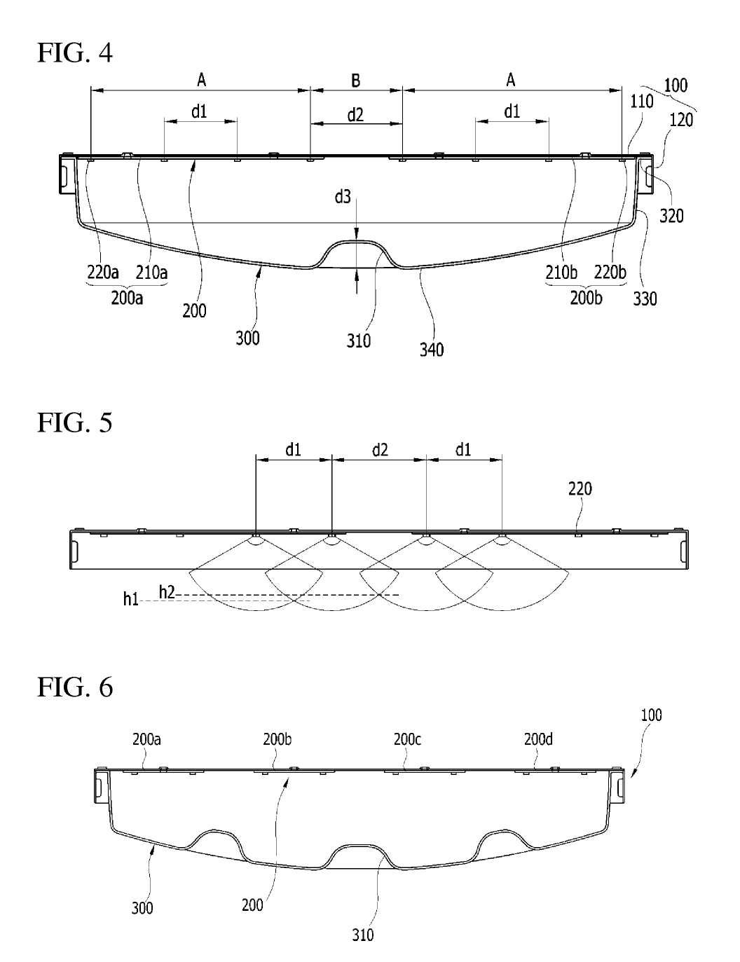

FIG. 1 is an exploded perspective view illustrating an LED lighting apparatus according to an exemplary embodiment of the present invention. FIG. 2 is an exploded cross-sectional view illustrating the LED lighting apparatus of FIG. 1. FIG. 3 is a cross-sectional view illustrating the LED lighting apparatus of FIG. 2, which is assembled. FIG. 4 is a cross-sectional view illustrating a housing and a diffusion cover of FIG. 2, which are combined with each other.

Referring to FIG. 1 through FIG. 4, an LED lighting apparatus according to an exemplary embodiment of the present invention includes a housing 100, a lighting module 200 combined with the housing 100, a diffusion cover 300 combined with the housing 100 such that the diffusion cover 300 covers the lighting module 200, and a power supply 400 proving the lighting module 200 with electric power. Additionally, the LED lighting apparatus may further include a frame 500 for installing the LED lighting apparatus.

The housing 100 has a receiving space for receiving the lighting module 200. For example, the housing 100 includes a flat panel 110 with which the lighting module 200 is combined, and four sidewalls 120 extending from edges of the flat panel 110 to define the receiving space. The housing 100 fixes the lighting module 200 and operates as a heat sink dissipating heats generated by the lighting module 200. For this, the housing 100 includes metal with high thermal conductivity for enhancing heat dissipation, and the flat panel 110 is exposed outside.

The lighting module 200 is combined with the flat panel 110 through a screw, a connector, a boss, etc., and generates light. The lighting module 200 includes a circuit board 210 combined with the housing 100, and a plurality of light emitting diodes mounted on the circuit board 210 to generate light. Each of the light emitting diodes may be a chip or a package.

Referring to FIG. 4, the lighting module 200 has a first region A in which light emitting diodes are arranged with a first distance d1 and a second region B in which light emitting diodes are arranged with a second distance d2 that is greater than the first distance d1. For example, the second region B is disposed between two first regions A at a center of the housing 100.

In detail, the lighting module 200 may include a first lighting module section 200a combined with the housing 100 at a first side of the housing 100, and a second lighting module section 200b spaced apart from the first lighting module section 200a and combined with the housing 100 at a second side of the housing, which is opposite to the first side.

The first lighting module section 200a includes a first circuit board 210a combined with the housing 100 at the first side of the housing 100, and a plurality of first light emitting diodes 220a mounted on the first circuit board 210a to generate light. The second lighting module section 200b includes a second circuit board 210b combined with the housing 100 at the second side of the housing 100, and a plurality of second light emitting diodes 220b mounted on the second circuit board 210b to generate light.

The first light emitting diodes 220a are arranged on the first circuit board 210a with the first distance d1, and the second light emitting diodes 220b are arranged on the second circuit board 210b with the first distance d1. That is, the first and second light emitting diodes 220a and 220b of the first and second lighting module sections 200a and 200b are arranged with the first distance d1. The first light emitting diodes 220a of the first lighting module section 200a, which are adjacent to the second lighting module section 200b, and the second light emitting diodes 220b of the second lighting module section 200b, which are adjacent to the first lighting module section 200a, are spaced apart with the second distance d2 that is greater than the first distance d1. Therefore, the second region B with the second distance d2 corresponds to a region between the first lighting module section 200a and the second lighting module section 200b.

The power supply 400 provides the lighting module 200 with electric power. The power supply 400 is combined with a back surface of the housing 100 in a region corresponding to the second region B of the lighting module 200. The power supply 400 converts commonly used electric power (for example, alternating electric power of 220V or 110V) to an appropriate electric power (for example, a direct electric power). For example, an SMPS (Switching Mode Power Supply) may be adopted as the power supply 400.

The power supply 400 is formed such that the power supply 400 extends along a lengthwise direction of the second region B. Preferably, the power supply 400 is formed that a width of the power supply 400 is within the second region B. However, the power supply 400 may be formed such that the width of the power supply 400 may invade the first region A. Further, instead of being disposed on the back surface of the housing 100, the power supply 400 may be disposed between the first and second lighting module sections 200a and 200b.

As described above, when a distance between the light emitting diodes 220 at a region corresponding to the power supply 400 is larger than that of other region, the number of the light emitting diodes may be reduced to reduce that manufacturing cost thereof, and a deterioration of the light emitting diodes 220, which is induced by electric interference and heat of the power supply 400, may be minimized.

The diffusion cover 300 is combined with the housing 100 such that the diffusion cover 300 covers the lighting module 200. The diffusion cover 300 may include material with high diffusion ratio to diffuse light generated by the light emitting diodes 220, which are point light source, to generate planar light source so that each of the light emitting diodes 220 cannot be seen outside of the diffusion cover 300 but the LED lighting apparatus can generate uniform light throughout the diffusion cover 300. The diffusion cover 300 may be formed by plastic material with high optical diffusing agent. Further, the diffusion cover 300 may have concavo-convex patterns on at least on surface of the diffusion cover 300 in order to diffuse light.

The diffusion cover 300 has a groove portion 310 in corresponding to the second region B in which the light emitting diodes 220 are spaced apart with the second distance d2. The diffusion cover 300 may have a combining portion 320 for a combination with the housing 100, a sidewall portion 330 extending from the combining portion 320, and a diffusing portion 340 extending from the sidewall portion 330 to the groove portion 310. For example, the combing portion 320 is combined with the housing 100 at an edge region of the flat panel 110, where the lighting module 200 is not formed. The sidewall portion 330 extends vertically from inner end portion of the combining portion 320. The sidewall portion 330 is longer than the sidewall 120 of the housing 100, so that the sidewall portion 330 of the diffusion cover 300 is exposed out of the housing 100. The diffusing portion 340 is formed at a region facing the lighting module 200 such that a distance between the diffusion portion 340 and the lighting module 200 gradually increases from the sidewall portion 330 to the groove portion 310. For example, the diffusing portion 340 may have a round shape with a specific curvature. Alternatively, the diffusing portion 340 may be flat so that a distance between the diffusing portion 340 and the lighting module 200 may be constant.

The groove portion 310 formed at the diffusion cover 300 is formed to reduce a dark region induced by the second region B in which the light emitting diodes 220 are arranged with the second distance d2 that is greater than the first distance d1 with which the light emitting diodes 220 are arranged in the first region A. The groove portion 310 extends along a longitudinal direction of the second region B. The groove portion 310 may have a curved shape when the groove portion 310 is cut along a direction that is vertical to the longitudinal direction of the second region B.

For example, a cross-section of the groove portion 310 may have a half-elliptical shape.

The depth d3 of the groove portion 310 may be determined by the height of two lights generated by adjacent two light emitting diodes 220, at which the two lights overlap with each other.

FIG. 5 is a conceptual view illustrating a light profile generated by lighting module.

Referring to FIG. 5, the light emitting diodes 220 emit light with substantially the same beam angle (for example 120°). Therefore, two lights generated by adjacent two light emitting diodes 220 overlap with each other. When a region, in which a distance between adjacent two light emitting diodes 220 is different, exists, a relative dark region may be generated since a height at which two lights generated by adjacent two light emitting diodes 220 overlap with each other. In detail, as shown in FIG. 4, a first height h1, at which two lights generated by two light emitting diodes 220 spaced apart from each other with the first distance d1 overlap with each other, is lower than a second height h2, at which two lights generated by two light emitting diodes 220 spaced apart from each other with the second distance d2 overlap with each other with respect to the flat panel 110, so that a dark region is generated at a center region.

Therefore, it is preferable that the groove portion 310 of the diffusion cover 300 is formed to have a depth substantially the same as a depth d3 that is the difference between the first height h1 and the second height h2. Additionally, the groove portion 310 of the diffusion cover 300 is disposed between a height at which the sidewall portion 330 and the diffusing portion 340 meet each other, and a height at which the diffusing portion 340 and the groove portion 310 meet each other.

As described above, when a groove portion 310 is formed at a region of the diffusing cover 300, where overlapping height is different, to have a depth substantially the same as the height difference, a relative dark region induced by the light overlapping height difference may be reduced.

FIG. 6 is a cross-sectional view illustrating an LED lighting apparatus according to another exemplary embodiment of the present invention.

Referring to FIG. 6, a lighting module 200 of an LED lighting apparatus according to another exemplary embodiment of the present invention includes a plurality of lighting module sections 200a, 200b, 200c and 200d which is spaced apart from each other and combined with the housing 100, and a diffusion cover 300 may have a plurality of groove portions 310 at regions corresponding to regions between the lighting module sections 200a, 200b, 200c and 200d, respectively. In FIG. 6, the LED lighting apparatus exemplarily has four lighting module sections 200a, 200b, 200c and 200d. However, the LED lighting apparatus may have no less than three lighting module sections. The LED lighting apparatus of the present invention is substantially the same as the LED lighting apparatus of the previous embodiment except that the LED lighting apparatus has no less than three lighting module sections, and the diffusion cover 300 have no less than two groove portions formed at regions corresponding to regions between the lighting module sections. Therefore, further repetitive explanation will be omitted.

The LED lighting apparatus may have the frame 500 for installing the LED lighting apparatus at a ceiling or a wall.

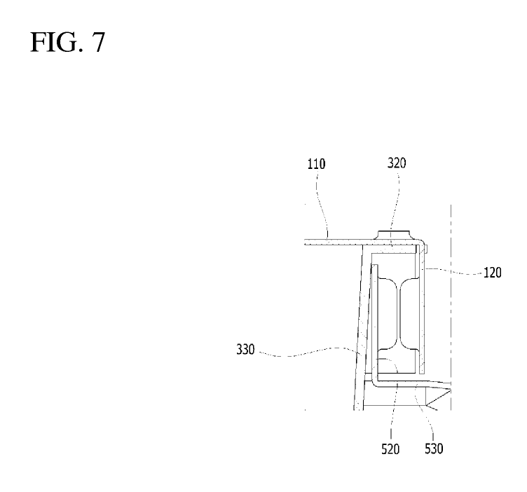

FIG. 7 is a partially enlarged view illustrating a combination of a housing and a frame.

Referring to FIG. 1, FIG. 2 and FIG. 7, the frame 500 has a lower side opening structure such that light generated by the lighting module 200 exits. Further, the frame 500 has an opening 510 for a combination with the housing 100 at a center portion. The frame 500 may include a material with high optical reflectivity or may be coated with a material with high reflectivity for reflecting light passing through the diffusion cover 300.

The frame 500 includes a housing-combination portion 520 for being combined with the housing 100, a frame portion 530 outwardly extending from the housing-combination portion 520, and an installing portion 540 through which the LED lighting apparatus is installed at a ceiling or a wall.

The housing-combination portion 520 is insulted between the sidewall 120 of the housing 100 and the sidewall portion 330 of the diffusion cover 300 to be combined with the sidewall 120 through a screw. The frame portion 530 extends outwardly and downwardly from the housing-combination portion 520, so that the frame portion 530 operates as a reflection cover. The installing portion 540, through which the LED lighting apparatus is installed to a ceiling or a wall, is vertically extended from the frame portion 530. The frame 500 may have similar structure to that of conventional frame for a fluorescent lamp. The frame 500 may have various shapes and structures for enhancing lighting efficiency.

The LED lighting apparatus with the frame 500 is installed to a ceiling or a wall, and operates as a direct light. When the frame 500 is combined with the housing 100, the diffusion cover 300 is not exposed out of the frame portion 530 in order to enhance lighting characteristics and a sense of beauty. Further, the diffusion surfaces of the diffusion cover 300 have decreasing height from a center portion to an edge portion with respect to the housing 100. Therefore, when the LED lighting apparatus is buried on the ceiling to be installed, the diffusion cover 300, which corresponds to a lighting surface, is disposed inside of the ceiling, and the light directly exiting from the diffusion cover 300 and the light reflected by the frame portion 530 are mixed with each other to illuminate uniformly.

On the other hand, the LED lighting apparatus with the diffusion cover 300 and without the frame 500 may be used as a pendant lighting apparatus. That is, the housing 100 and the frame 500 are separable combined, so that the LED lighting apparatus according to the present invention may be used as a buried lighting apparatus or a pendant lighting apparatus.

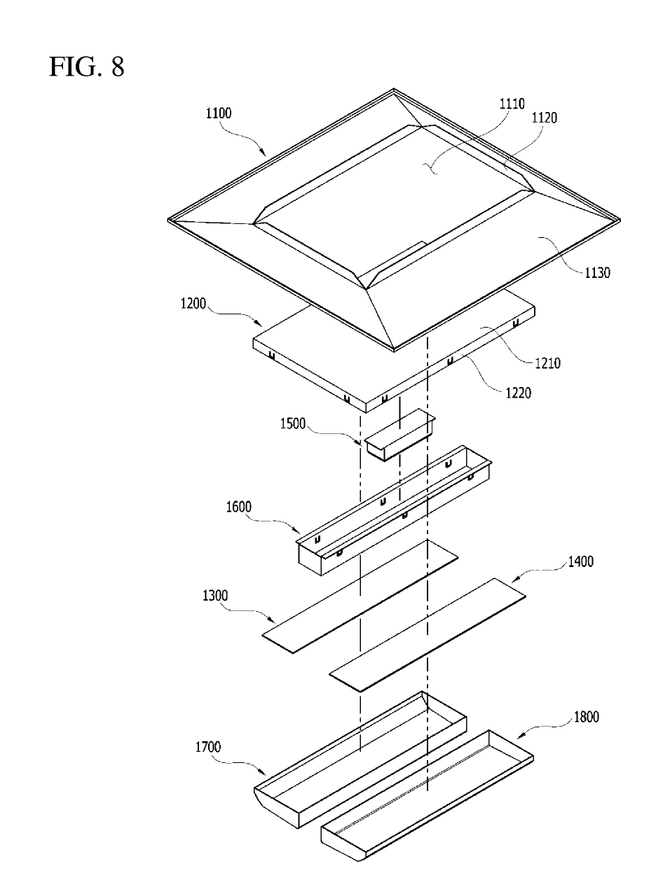

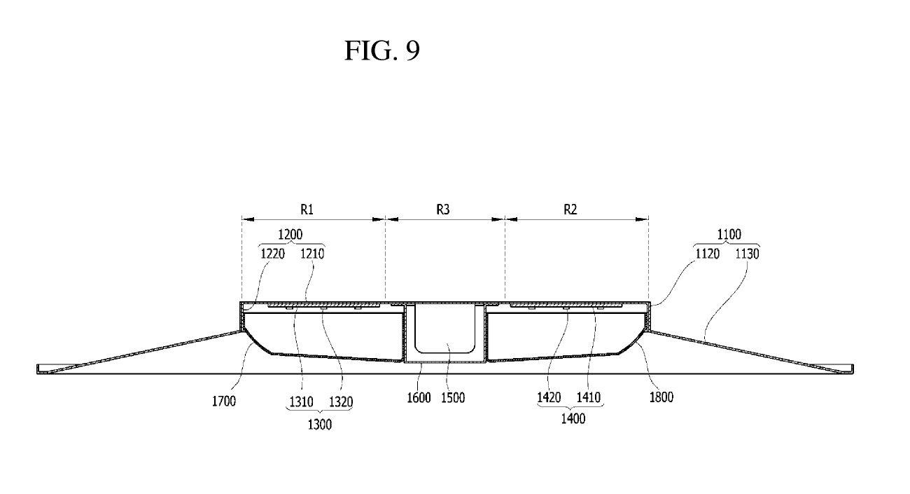

FIG. 8 is an exploded perspective view illustrating an LED lighting apparatus according to another exemplary embodiment of the present invention, and FIG. 9 is cross-sectional view illustrating the LED of FIG. 8, which is assembled.

Referring to FIG. 8 and FIG. 9, an LED lighting apparatus according to another exemplary embodiment of the present invention includes a housing 1100, a heat sink 1200, a first lighting module 1300, a second lighting module 1400 and a power supply 1500. Additionally, the LED lighting apparatus may include a power supply cover 1600 covering the power supply 1500, a first diffusion cover 1700 covering the first lighting module 1300, and a second diffusion cover 1800 covering the second lighting module 1400.

The LED lighting apparatus having the above mentioned structure is buried on the ceiling and directly illuminates.

The housing 1100 has a structure for effectively exiting light generated by the first lighting module 1300 and the second lighting module 1400. The housing 1100 may have an opening 1110 at a center portion thereof for a combination with the heat sink 1200. Alternatively, the housing 1100 do not have the opening 1110. The housing 1100 may include a material with high optical reflectivity or be coated with a material with high optical reflectivity in order to reflect light generated by the first and second lighting modules 1300 and 1400.

The housing 1100 may have a heat sink combining portion 1120, through which the heat sink 1200 inserted into the opening 1110 is combined, and a slant portion 1130 extended slantly from the sink combining portion 1120. The sink combining portion 1120 is formed such that the sink combining portion 1120 surrounds the heat sink 1200, which is inserted into the opening 1110, and is combined with the heat sink 1200 through a screw. The slant portion 1130 extends outwardly and slantly from the heat sink combining portion 1120 and reflects light. The housing 1100 may have similar structure to that of conventional housing for a fluorescent lamp. The housing 1100 may have various shapes and structures for enhancing lighting efficiency.

The heat sink 1200 is disposed inside of the housing 1100. For example, the heat sink 1200 is inserted into the opening 1110 of the housing 1100 and fixed to the housing 1100. The first lighting module 1300, the second lighting module 1400 and the power supply 1500 are fixed to the heat sink 1200, so that the heat sink 1200 dissipates heats generated by the first lighting module 1300, the second lighting module 1400 and the power supply 1500.

The heat sink 1200 has a flat portion 1210, on which the first lighting module 1300, the second lighting module 1400 and the power supply 1500 are mounted, and four sidewall portions 1220 vertically extended from four edges of the flat portion 1210, respectively. The sidewall portions 1220 are combined with the heat sink combining portion 1120 through a screw. The backside of the flat portion 1210 is exposed outside to enhance heat dissipation efficiency. The heat sink 1200 may include a metal with high thermal conductivity such as aluminum (Al) or magnesium (Mg).

The first lighting module 1300 is mounted on a first region R1 of the heat sink 1200.

The second lighting module 1400 is mounted on a second region R2 of the heat sink 1200, which is spaced apart from the first region R1. The first and second lighting modules 1300 and 1400 generate light and may be combined with the flat portion 1210 of the heat sink 1200 through various methods such as a screw, a connector, a boss, etc.

The first lighting module 1300 includes a first circuit board 1310 combined with the heat sink 1200, and a plurality of first light emitting diodes 1320 mounted on the first circuit board 1310. The second lighting module 1400 includes a second circuit board 1410 combined with the heat sink 1200, and a plurality of second light emitting diodes 1420 mounted on the second circuit board 1410. The first and second light emitting diodes 1320 and 1420 are arranged uniformly on the first and second circuit boards 1310 and 1410, respectively. Each of the first and second light emitting diodes 1320 and 1420 may be a chip or a package.

The power supply 1500 provides the first and second lighting modules 1300 and 1400 with electric power, and is disposed in a third region R3 of the heat sink 1200, which is disposed between the first and second regions R1 and R2. The power supply 1500 converts commonly used electric power (for example, alternating electric power of 220V or 110V) to an appropriate electric power (for example, a direct electric power) for the first and second light emitting diodes 1320 and 1420. For example, an SMPS (Switching Mode Power Supply) may be adopted as the power supply 1500.

According to the present embodiment, the first lighting module 1300, the second lighting module 1400 and the power supply 1500 are disposed on the same plane (that is on the inner surface of the heat sink 1200). Therefore, a thickness of the LED lighting apparatus may be reduced. Further, the LED lighting apparatus may be repaired or a component of the LED lighting apparatus may be replaced without separating the LED lighting apparatus from a ceiling or a wall. Furthermore, the first and second lighting modules 1300 and 1400 are disposed with the power supply 1500 therebetween. The first and second lighting modules 1300 and 1400 generate light with a specific spreading angle. Therefore, even though the power supply 1500 is disposed between the first and second lighting modules 1300 and 1400, the power supply 1500 does not block the light generated by the first and second lighting modules 1300 and 1400. For example, considering the lighting characteristics of the LED lighting apparatus, a width of the third region R3, in which the power supply 1500 is disposed, is preferably no greater than about 30% of total width R1+R2+R3. Further when the power supply 1500 is embodied through an integrated circuit (IC), the third region R3 may be reduced to no greater than 5%.

The LED lighting apparatus may further include the power supply cover 1600 covering the power supply 1500.

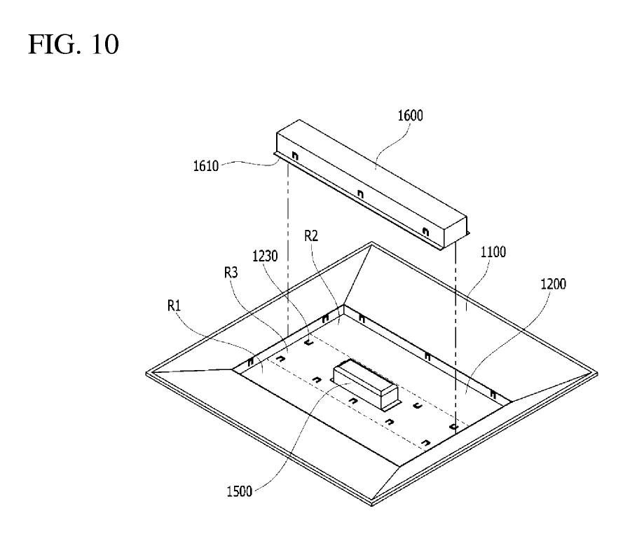

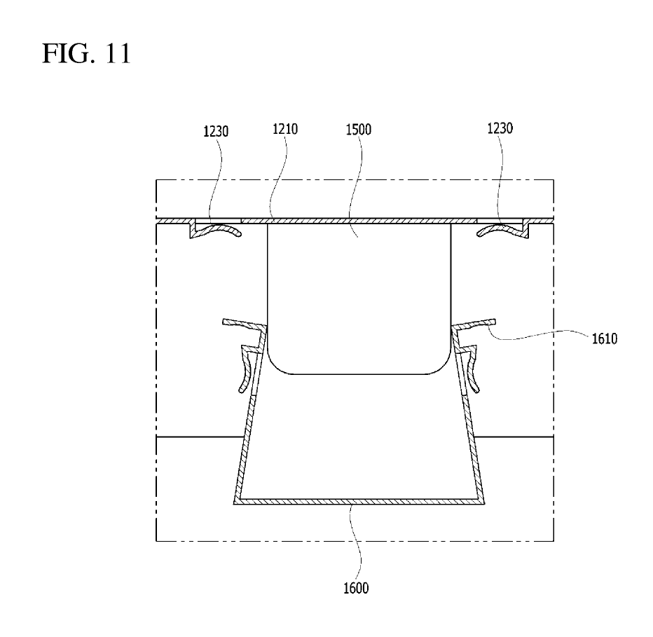

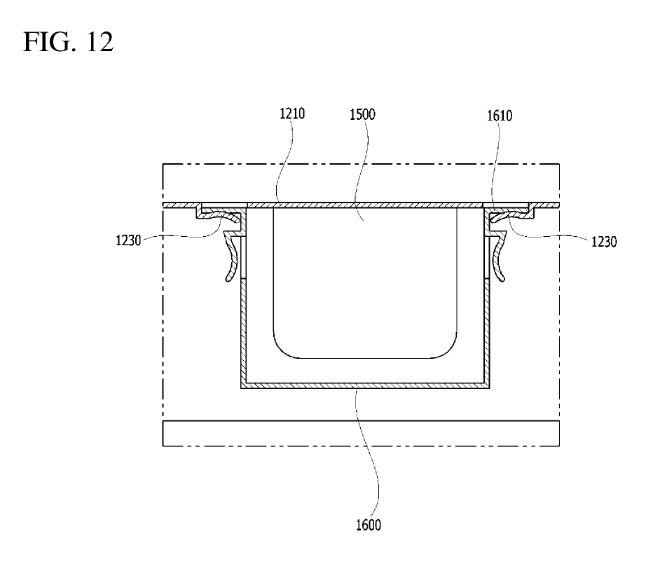

FIG. 10 is an exploded perspective view illustrating a process of assembling power supply cover. FIG. 11 is a cross-sectional view illustrating a process of assembling power supply cover, and FIG. 12 is a cross-sectional view illustrating the power supply cover which is assembled.

Referring to FIG. 10, FIG. 11 and FIG. 12, the power supply cover 1600 is combined with the flat portion 1210 of the heat sink 1200 to cover the power supply 1500.

The power supply cover 1600 may be combined with the heat sink 1200 through a Z-bending for convenience of assembling and disassembling. In order for that, the heat sink 1200 has a plurality of first Z-bending portions 1230 formed at the flat portion 1310, which is for a combination with the power supply cover 1600. For example, at least one the first Z-bending portion 1230 is formed at each side with respect to the power supply 1500, respectively. The first Z-bending portion 1230 is formed by partial cutting and bending, and a first side of the first Z-bending portion 1230, which faces the power supply 1500 is opened and a second side of the first Z-bending portion 1230, which is opposite to the first side, is closed.

The power supply cover 1600 includes a bending combination portion 1610 formed at the side end of the power supply cover 1600, through which the power supply cover 1600 is combined with the first Z-bending portion 1230. The bending combination portion 1610 and the first Z-bending portion 1230 are combined with each other through a flexibility of the power supply cover 1600. In detail, in order to combine the bending combination portion 1610 and the first Z-bending portion 1230 with each other, two side of the power supply cover 1600 are compressed and the power supply cover 1600 is moved to the flat portion 1210 of the heat sink 1200. Then, the two side of the power supply cover 1600 are released, so that the bending combination portion 1610 is inserted into the first Z-bending portion 1230 to be combined with the first Z-bending portion 1230. The bending combination portion 1610 may have a combination hole or a combination groove formed at a region corresponding to the first Z-bending portion 1230.

The LED lighting apparatus may further include the first and second diffusion covers 1700 and 1800 covering the first and second lighting modules 1300 and 1400, respectively.

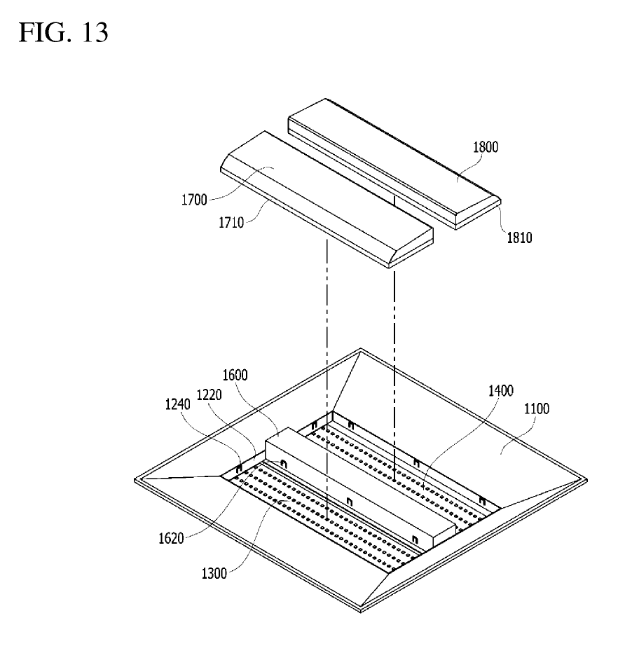

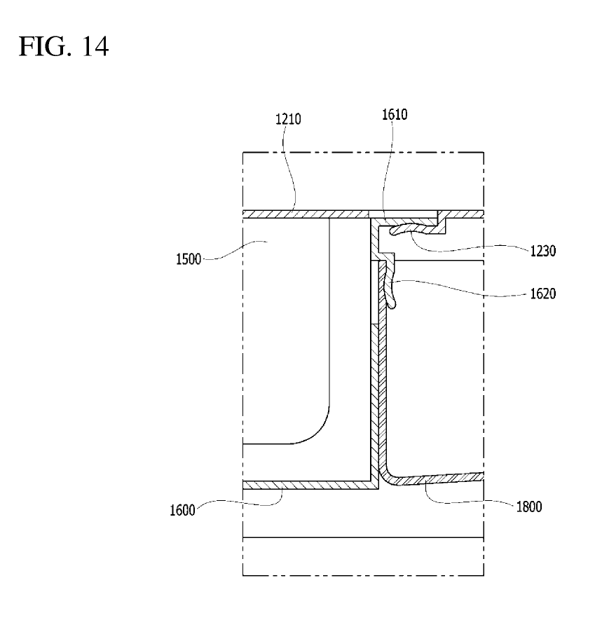

FIG. 13 is an exploded perspective view illustrating a process of assembling a diffusion cover, and FIG. 14 is a cross-sectional view illustrating the diffusion cover which is assembled.

Referring to FIG. 13 and FIG. 14, the first and second diffusion covers 1700 and 1800 are combined with the heat sink 1200 and the power supply cover 1600 to cover the first and second lighting modules 1300 and 1400, respectively. Therefore, the first and second diffusion covers 1700 and 1800 are spaced apart from each other with the power supply cover 1600 interposed therebetween.

The first and second diffusion covers 1700 and 1800 may include material with high diffusion ratio to diffuse light generated by the first and second light emitting diodes 1320 and 1420, which are point light source, to generate planar light source so that each of the first and second light emitting diodes 1320 and 1420 cannot be seen outside of the first and second diffusion covers 1700 and 1800 but the LED lighting apparatus can generate uniform light throughout the first and second diffusion covers 1700 and 1800. The first and second diffusion covers 1700 and 1800 may be formed by plastic material with high optical diffusing agent. Further, the first and second diffusion covers 1700 and 1800 may have concavo-convex patterns on at least on surface of the first and second diffusion covers 1700 and 1800 in order to diffuse light.

The first and second diffusion covers 1700 and 1800 may be combined with the heat sink 1200 and the power supply cover 1600 through a Z-bending method for a convenience of assembling or disassembling. In order for that, the heat sink 1200 may include a second Z-bending portion 1240 for a combination with the first and second diffusion covers 1700 and 1800. For example, at least one the second Z-bending portion 1240 may be formed at the four sidewall portions 1220, respectively. The second Z-bending portion 1240 is formed by partial cutting and bending, and a first side of the second Z-bending portion 1240, which faces the first and second diffusion covers 1700 and 1800, is opened, and a second side of the second Z-bending portion 1240, which is opposite to the first side, is closed.

The power supply cover 1600 may further include a third Z-bending portion 1620 for a combination with the first and second diffusion covers 1700 and 1800. The third Z-bending portion 1620 is formed at outer face of the power supply cover 1600.

For example, a plurality of the third Z-bending portions 1620 may be formed at each side of the power supply cover 1600. A portion of the power supply cover 1600 is partially cut and bent to form the third Z-bending portion 1620. A first side of the third Z-bending portion 1620, which faces the first and second diffusion covers 1700 and 1800, is open, and a second side of the third Z-bending portion 1620, which is opposite to the first side, is closed.

The first diffusion cover 1700 includes a first diffusion cover combination portion 1710 for being combined with the second Z-bending portion 1240 and the third Z-bending portion 1620. Through compressing of the first diffusion cover 1700, the first diffusion cover combination portion 1710 is inserted into the second Z-bending portion 1240 and the third Z-bending portion 1620 and combined with the second Z-bending portion 1240 and the third Z-bending portion 1620. The second diffusion cover 1800 includes a second diffusion cover combination portion 1810 for being combined with the second Z-bending portion 1240 and the third Z-bending portion 1620. Through compressing of the second diffusion cover 1800, the second diffusion cover combination portion 1810 is inserted into the second Z-bending portion 1240 and the third Z-bending portion 1620 and combined with the second Z-bending portion 1240 and the third Z-bending portion 1620. The first and second diffusion cover combination portions 1710 and 1810 may have a combination hole or a combination groove formed at region corresponding to the second Z-bending portion 1240 and the third Z-bending portion 1620.

As described above, when the power supply cover 1600 is combined with the first and second diffusion covers 1700 and 1800 through the Z-bending method, a convenience for assembling or disassembling may be improved in comparison with a screw method.

Referring again to FIG. 9, in order to enhance lighting characteristics and a sense of beauty of the LED lighting apparatus, the power supply cover 1600, the first diffusion cover 1700 and the second diffusion cover 1800 which are assembled are not exposed out of the slant portion 1130 of the housing 1100. Further, the diffusion surfaces of the first and second diffusion covers 1700 and 1800 have decreasing height from the power supply cover 1600 to opposite edge portion, considering lighting characteristics. Therefore, when the LED lighting apparatus is buried on the ceiling to be installed, the first and second diffusion covers 1700 and 1800, which correspond to a lighting surface, are disposed inside of the ceiling, and the light directly exiting from the first and second diffusion covers 1700 and 1800 and the light reflected by the slant portion 1130 of the housing 1100 are mixed with each other to illuminate uniformly.

Hereinafter, a method of assembling the LED lighting apparatus will be explained referring to FIG. 8 through FIG. 14.

Referring to FIG. 8 and FIG. 9, in order to assemble the LED lighting apparatus, the heat sink 1200 is inserted into the opening 1110 of the housing 1100. For example, the sidewall portion 1220 of the heat sink 1200 is combined with the heat sink combination portion 1120 of the housing 1100 through a screw.

Then, as shown in FIG. 10, the power supply 1500 is combined with the heat sink 1200 such that the power supply 1500 is disposed in the third region R3 between the first and second regions R1 and R2. For example, the power supply 1500 may be combined with the heat sink 1200 through a screw.

Then, as shown in FIG. 11 and FIG. 12, the power supply cover 1600 covering the power supply 1500 is combined with the flat portion 1210 of the heat sink 1200. For example, using flexibility of the power supply cover 1600, the power supply cover 1600 is combined with the first Z-bending portion 1230. That is, two side of the power supply cover 1600 are compressed and the power supply cover 1600 is moved to the flat portion 1210 of the heat sink 1200. Then, the two side of the power supply cover 1600 are released, so that the bending combination portion 1610 is inserted into the first Z-bending portion 1230 to be combined with the first Z-bending portion 1230. The bending combination portion 1610 may have a combination hole or a combination groove formed at a region corresponding to the first Z-bending portion 1230.

Then, as shown in FIG. 13, the first lighting module 1300 is combined with the heat sink 1200 in the first region R1 of the heat sink 1200, and the second lighting module 1400 is combined with the heat sink 1200 in the second region R2 of the heat sink 1200, which is spaced apart from the first region R1. For example, the first and second lighting modules 1300 and 1400 may be combined with the heat sink 1200 through a screw. Alternatively, the first and second lighting modules 1300 and 1400 may be combined with the heat sink 1200 before, the combining the power supply 1500 and the power supply cover 1600 with the heat sink 1200.

Then, the first and second diffusion covers 1700 and 1800 covering the first and second lighting modules 1300 and 1400, respectively are combined with the heat sink 1200 and the power supply cover 1600. For example, the first and second diffusion covers 1700 and 1800 are compressed to be inserted into and combined with the second Z-bending portion 1240 of the heat sink 1200 and the third Z-bending portion 1620 of the power supply cover 1600. The first and second diffusion cover combination portions 1710 and 1810 may have a combination hole or a combination groove formed at region corresponding to the second Z-bending portion 1240 and the third Z-bending portion 1620.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A light emitting diode (LED) lighting apparatus, comprising:
a housing;
a lighting module including a circuit board combined with the housing, and a plurality of light emitting diodes mounted on the circuit board to generate light, the light emitting diodes in a first region being arranged with a first distance and the light emitting diodes in a second region being arranged with a second distance that is greater than the first distance; and
a diffusion cover combined with the housing such that the diffusion cover covers the lighting module, the diffusion cover having a groove portion at a region corresponding to the second region.

2. The LED lighting apparatus of claim 1, further comprising:
a power supply combined with the housing in a region corresponding to the second region, the power supply providing the lighting module with electric power.

3. The LED lighting apparatus of claim 1, wherein the second region is disposed between two first regions.

4. The LED lighting apparatus of claim 1, wherein the lighting module comprises:
a first lighting module section combined with the housing at a first side; and
a second lighting module section combined with the housing at a second side opposite to the first side such that the second lighting module section is spaced apart from the first lighting module section.

5. The LED lighting apparatus of claim 4, the second region corresponds to a region between the first and second lighting module sections.

6. The LED lighting apparatus of claim 1, wherein the lighting module comprises at least three lighting module sections combined with the housing such that the lighting module sections are spaced apart from each other,
and a plurality of groove portions are formed at a region between the lighting modules, respectively.

7. The LED lighting apparatus of claim 1, wherein the groove portions extend along a longitudinal direction of the second region.

8. The LED lighting apparatus of claim 7, wherein the groove portion has a rounded cross-sectional shape.

9. The LED lighting apparatus of claim 1, wherein the groove portion has a depth corresponding to a difference of a first height, at which two lights emitted by two light emitting diodes spaced apart from each other with the first distance overlap, and a second height at which two lights emitted by two light emitting diodes spaced apart from each other with the second distance overlap.

10. The LED lighting apparatus of claim 1, wherein the diffusion cover, comprises:
a combination portion combined with the housing;
a sidewall portion extending from the combination portion; and
a diffusing portion extending from the sidewall portion to the groove portion.

11. The LED lighting apparatus of claim 10, wherein the diffusing portion is formed such that a distance between the diffusion portion and the lighting module gradually increases from the sidewall portion to the groove portion.

12. The LED lighting apparatus of claim 10, wherein the groove portion is disposed between a height at which the sidewall portion and the diffusing portion meet each other, and a height at which the diffusing portion and the groove portion meet each other.

13. The LED lighting apparatus of claim 10, further comprising:
a frame for installing the LED lighting apparatus to outside, which is combined with the housing.

14. The LED lighting apparatus of claim 13, wherein the frame comprises:
a housing-combination portion disposed between a sidewall of the housing and the sidewall portion of the diffusion cover to be combined with the housing;
a frame portion outwardly extending from the housing-combination portion; and
a installing portion for installing the LED lighting apparatus to outside, which formed at an edge of the frame portion.

15. A light emitting diode (LED) lighting apparatus comprising:
a housing;
a lighting module having a first lighting module section combined with the housing at one side, and a second lighting module section combined with the housing at an opposite side such that the second lighting module section is spaced apart from the first lighting module section;
a power supply combined with a back surface of the housing to provide the lighting module with electric power; and
a diffusion cover combined with the housing to cover the lighting module, the diffusion cover having a groove portion at a region thereof, which corresponds to a region between the first and second lighting module sections.

16. The LED lighting apparatus of claim 15, wherein the first and second lighting modules section respectively include light emitting diodes arranged with a first distance,
and a light emitting diode of the first lighting module section, which is nearest to the second light module section, and a light emitting diode of the second lighting module section, which is nearest to the first lighting module section, are spaced apart with a second distance.

17. The LED lighting apparatus of claim 15, further comprising:
a frame for installing the LED lighting apparatus to outside.
